(19) United States
(12) Patent Application Publication
(10) Pub. No.: US 2004/0002854 A1
(43) Pub. Date: Jan. 1, 2004

(54) Audio coding method and apparatus using harmonic extraction

(75) Inventor: Ho-jin Ha, Seoul (KR)

Correspondence Address: SUGHRUE MION, PLLC, 2100 Pennsylvania Avenue, NW, Washington, DC, 20037-3213, US

(73) Assignee: SAMSUNG ELECTRONICS CO., LTD.

(21) Appl. No.: 10/340,828

(22) Filed: Jan. 13, 2003

(30) Foreign Application Priority Data
Jun. 27, 2002 (KR) 2002-36310

(51) Int. Cl. G10L 19/00

(52) U.S. Cl. 704/212

(57) ABSTRACT

A method and apparatus for effectively encoding an audio signal into a Moving Picture Experts Group (MPEG)-1 layer III audio signal of a low-speed bitrate. In the audio encoding method, harmonic components are extracted using fast Fourier transformation (FFT) result information that is obtained by applying psycho-acoustic model 2 to received pulse code modulation (PCM) audio data. Then, the extracted harmonic components are removed from the received PCM audio data. Thereafter, the PCM audio data from which the extracted harmonic components are removed is subjected to a modified discrete cosine transform (MDCT) and quantization. Accordingly, efficient encoding can be achieved even using a small number of allocated bits.

### BACKGROUND OF THE INVENTION

This application claims the priority of Korean Patent Application No. 2002-36310, filed Jun. 27, 2002, in the Korean Intellectual Property Office, the disclosure of which is incorporated herein in its entirety by reference.

1. Field of the Invention

The present invention relates to a method of compressing an audio signal, and more particularly, to a method of and apparatus for efficiently compressing an audio signal into an MPEG-1 layer-3 audio signal with a low-speed bit rate.

2. Description of the Related Art

In the related art, Moving Picture Experts Group-1 (MPEG-1) establishes standards regarding digital video compression and digital audio compression, and is supported by the International Standardization Organization (ISO). The MPEG-1 audio standard is used to compress 16-bit audio that is sampled at a 44.1 Khz sampling rate, stored on a 60-minute or 72-minute CD and is classified into 3 layers (i.e., I, II and III) according to a compression method and the complexity of a codec.

Layer III is the most complex layer, uses more filters than layer II, and adopts Huffman coding. Upon encoding at 112 Kbps, an excellent-quality sound results. Upon encoding at 128 Kbps, a sound substantially similar to the original sound is obtained. Upon encoding at 160 Kbps or 192 Kbps, the resulting sound cannot be distinguished from the original sound by a human ear. In general, MPEG-1 layer-3 audio is referred to as MP3 audio.

In the related art, MP3 audio is produced using a discrete cosine transform (DCT), bit allocation based on psycho-acoustic model 2, quantization, and the like. More specifically, while the number of bits used to compress audio data is minimized, modified DCT (MDCT) is performed using the result of psycho-acoustic model 2.

In the related art audio compression techniques, the human ear is the most important consideration. The human ear cannot hear if the intensity of a sound is at or below a predetermined level. For example, if someone talks loudly in an office, the human ear can easily recognize who is talking. However, if an airplane passes by the office at that moment, the talking person cannot be heard. Further, even after the airplane has passed, the talking still cannot be heard because of a lingering sound. Accordingly, in psycho-acoustic model 2, data having a volume equal to or greater than a masking threshold is sampled among data having a volume equal to or greater than the minimum audible limit corresponding to how the sound is presented when it is quiet. The sampling is performed on each sub-band.

However, when a sound signal is compressed at a low-speed bit rate of no more than 64 Kbps, psycho-acoustic model 2 is not suitable because the number of bits used to quantize a signal such as a pre-echo signal is limited. To overcome the related art problem caused by low-speed MP3 audio, the present invention provides a method of effectively processing an audio signal at a low speed by removing a harmonic component from an original signal using a fast Fourier transform (FFT) adopted in psycho-acoustic model 2 and compressing only a transient component using MDCT.

In an FFT process adopted in a conventional psycho-acoustic model, only signal analysis is performed, and the result of the FFT is not used. Since the result of the FFT is not used for signal compression in the related art, it can be considered to be a waste of resources.

Korean Patent Publication No. 1995-022322 discloses a bit allocation method employing a psycho-acoustic model. However, the aforementioned disclosed method is different from a method of the present invention for increasing compression efficiency by removing a harmonic component from an original signal using the result of an FFT adopted in a psycho-acoustic model. The aforementioned disclosed method relates to bit allocation method by setting up an auxiliary audio data region virtually, and does not use residue harmonics as is done in the present invention.

Korean Patent Publication No. 1998-072457 discloses a signal processing method and apparatus in the psycho-acoustic model 2, by which the amount of computation is significantly reduced by reducing computation overload while compressing an audio signal. That is, the disclosed signal processing method includes a step of obtaining an individual masking boundary value using an FFT result, a step of selecting a global masking boundary value, and a step of shifting to the next frequency position. This method is the same as the present invention in that an FFT result value is used, but it is different in that it uses a different quantization method.

U.S. Pat. No. 5,930,373 discloses a method for enhancing the quality of a sound signal using the residue harmonics of a low frequency signal. However, the disclosed method and the quantization method according to the present invention are different in that they use different techniques of using residue harmonics.

### SUMMARY OF THE INVENTION

To solve the above and other problems, it is an aspect of the present invention to provide a method of effectively processing an audio signal at a low speed by removing a harmonic component from an original audio signal using the result of a fast Fourier transform (FFT) used in psycho-acoustic model 2 and compressing only a residue transient using a modified discrete cosine transform (MDCT).

The above and other aspects of the present invention are achieved by an audio coding method using harmonic components. In this method, first, pulse code modulation (PCM) audio data are received, and harmonic components are extracted from the received PCM audio data by applying psycho-acoustic model 2. Next, a modified discrete cosine transform (MDCT) is performed on the received PCM audio data from which the extracted harmonic components are removed. Thereafter, the MDCTed audio data is quantized, and an audio packet is produced from quantized audio data and the extracted harmonic components.

The above and other aspects of the present invention are also achieved by an audio coding method using harmonic components, in which PCM audio data is first received and stored. Then, psycho-acoustic model 2 based on the audible limit characteristics of a human ear is applied to the stored data to obtain fast Fourier transformation (FFT) result, perceptual energy information regarding received data, and bit allocation information used for quantization. Thereafter, harmonic components are extracted from the received PCM audio data using the FFT result information. Next, the extracted harmonic components are encoded, and the encoded harmonic components are decoded. Then, a MDCT is performed on a number of samples of the received PCM audio data from which the extracted harmonic components are removed, which depends on the value of the perceptual energy information. Thereafter, the MDCTed audio data is quantized by allocating bits according to the bit allocation information. Finally, an audio packet is produced from the quantized, MDCTed audio data and the encoded harmonic components.

The above and other aspects of the present invention are still achieved by an audio coding apparatus using harmonic components. In the apparatus, a PCM audio data storage unit receives and stores PCM audio data. A psycho-acoustic model 2 performing unit receives the PCM audio data from the PCM audio data storage unit and performs psycho-acoustic model 2 to obtain FFT result information, perceptual energy information regarding received data, and bit allocation information used for quantization. A harmonic extraction unit extracts harmonic components from the received PCM audio data using the FFT result information. A harmonic encoding unit encodes the extracted harmonic components outputting encoded harmonic components. A harmonic decoding unit decodes the encoded harmonic components. An MDCT unit performs a MDCT on the stored PCM audio data from which the decoded harmonic components are removed, according to the perceptual energy information. A quantization unit quantizes the MDCTed audio data according to the bit allocation information. An MPEG layer III bitstream production unit transforms the quantized, MDCTed audio data and the encoded harmonic components output from the harmonic encoding unit into an MPEG audio layer III packet.

To achieve the above and other aspects, the present invention provides a computer readable recording medium which stores a computer program for executing the above methods.

### BRIEF DESCRIPTION OF THE DRAWINGS

The above aspect and advantages of the present invention will become more apparent by describing in detail preferred embodiments thereof with reference to the attached drawings in which:

FIG. 1 shows the format of an MPEG-1 layer III audio stream according to a non-limiting preferred embodiment of the present invention;

FIG. 2 is a block diagram of an apparatus for producing an MPEG-1 layer III audio stream according to the non-limiting preferred embodiment of the present invention;

FIG. 3 is a flowchart illustrating a computation process in a psycho-acoustic model according to the non-limiting preferred embodiment of the present invention;

FIG. 4 is a block diagram of an apparatus according to the non-limiting preferred embodiment of the present invention for producing a low-speed MPEG-1 layer III audio stream;

FIG. 5 is a flowchart illustrating harmonic extraction, harmonic encoding, and harmonic decoding based on psycho-acoustic model 2 according to the non-limiting preferred embodiment of the present invention;

FIGS. 6A, 6B, 6C, and 6D illustrate harmonic component samples extracted in stages in order to extract harmonic components using an FFT result in psycho-acoustic model 2 according to the non-limiting preferred embodiment of the present invention;

FIG. 7 is a table showing limited frequency ranges varying according to K values according to the non-limiting preferred embodiment of the present invention; and

FIG. 8 is a flowchart illustrating a process according to the non-limiting preferred embodiment of the present invention for producing an audio stream by removing a harmonic component.

### DETAILED DESCRIPTION OF THE INVENTION

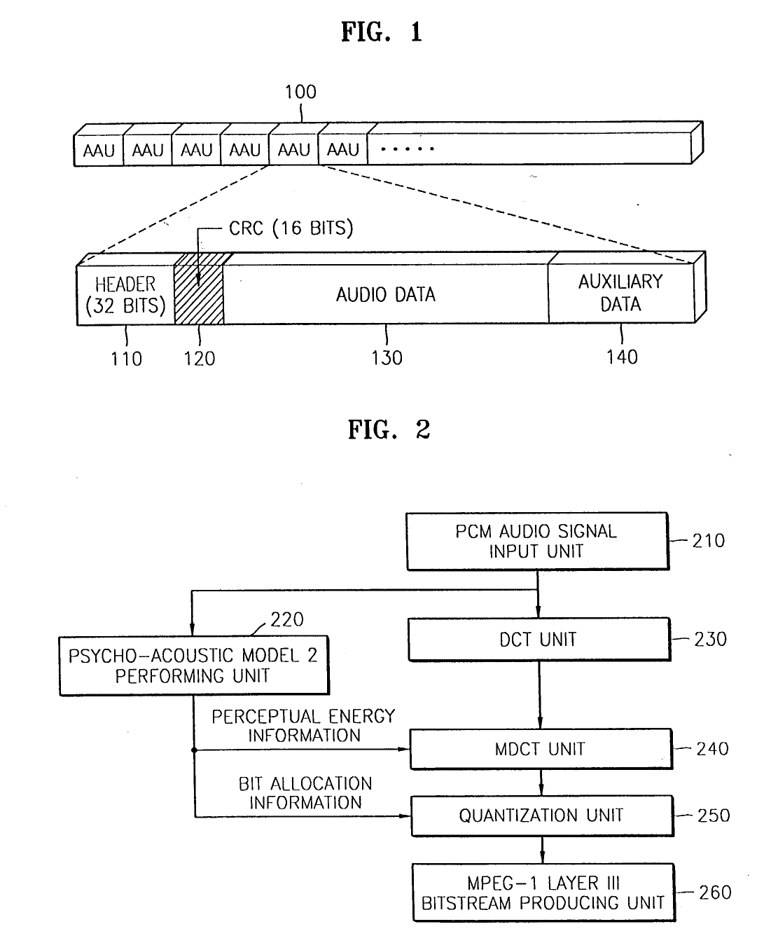

Referring to FIG. 1, a moving picture experts group (MPEG)-1 layer III audio stream is composed of audio access units (AAUs) 100. Each AAU 100 is a minimal unit that can be independently accessed, and compresses and stores data with a fixed number of samples. The AAU 100 includes a header 110, a cyclic redundancy check (CRC) 120, audio data 130, and auxiliary data 140.

The header 110 stores a syncword, ID information, layer information, information regarding whether a protection bit exists, bitrate index information, sampling frequency information, information regarding whether a padding bit exists, a private bit, mode information, mode extension information, copyright information, information regarding whether an audio stream is an original one or a copy, and information on emphasis characteristics.

In the exemplary, non-limiting embodiment of the present invention, the CRC 120 is optional. The presence or absence of the CRC 120 is defined in the header 110, and the length of the CRC 120 is 16 bits. The audio data 130 is a portion into which compressed audio data is inserted. The auxiliary data 140 is data filled into a space remaining when the end of the audio data 130 does not reach the end of an AAU. Arbitrary data other than MPEG audio can be inserted into the auxiliary data 140.

FIG. 2 is a block diagram of an apparatus for producing an MPEG-1 layer III audio stream. A pulse code modulation (PCM) audio signal input unit 210 has a buffer in which PCM audio data is stored. Here, the PCM audio signal input unit 210 receives, as the PCM audio data, granules, each composed of 576 samples.

A psycho-acoustic model 2 performing unit 220 receives the PCM audio data from the buffer of the PCM audio signal input unit 210 and performs psycho-acoustic model 2. A discrete cosine transforming (DCT) unit 230 receives the PCM audio data in units of granules, and performs a DCT operation at a substantially same time as when psycho-acoustic model 2 is performed.

After the DCT unit 230 performs the DCT operation, a modified DCT (MDCT) unit 240 performs a MDCT using the result of the application of psycho-acoustic model 2 (e.g., perceptual energy information) and the result of the DCT performed by the DCT unit 230. If perceptual energy is greater than a predetermined threshold, the MDCT is performed using a short window. If the perceptual energy is smaller than the predetermined threshold, the MDCT is performed using a long window.

In perceptual coding, which is an audio signal compression technique, a reproduced signal is different from an original signal. That is, detailed information that people cannot perceive using the characteristics of the human ear can be omitted. Perceptual energy denotes energy that a human can perceive.

A quantization unit 250 performs quantization using bit allocation information generated as a result of the application of psycho-acoustic model 2 via the psycho-acoustic model 2 performing unit 220 and using the result of the MDCT operation via the MDCT unit 240. A MPEG-1 layer III bitstream producing unit 260 transforms the quantized data into data to be inserted into an audio data area of an MPEG-1 bitstream, using Huffman coding.

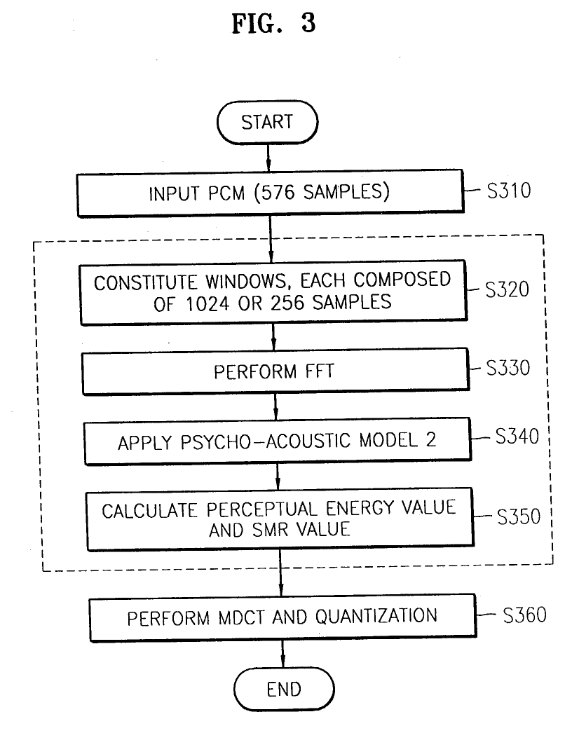

FIG. 3 is a flowchart illustrating a computation process in a psycho-acoustic model. First, PCM audio data is received in granules, each composed of 576 samples, in step S310. Next, long windows, each composed of 1024 samples, or short windows, each composed of 256 samples, are formed using the received PCM audio data, in step S320. That is, one packet is constituted of multiple samples.

Thereafter, in step S330, a fast Fourier transform (FFT) is performed one window at a time on the windows formed in step S320. Then, psycho-acoustic model 2 is applied, in step S340. In step S350, a perceptual energy value is obtained through the application of psycho-acoustic model 2 and applied to a MDCT unit and the MDCT unit selects a window to be applied. A signal to masking ratio (SMR) value for each threshold bandwidth is calculated and applied to a quantization unit to determine the number of bits to be allocated.

Finally, MDCT and quantization are performed using the perceptual energy value and the SMR value, in step S360.

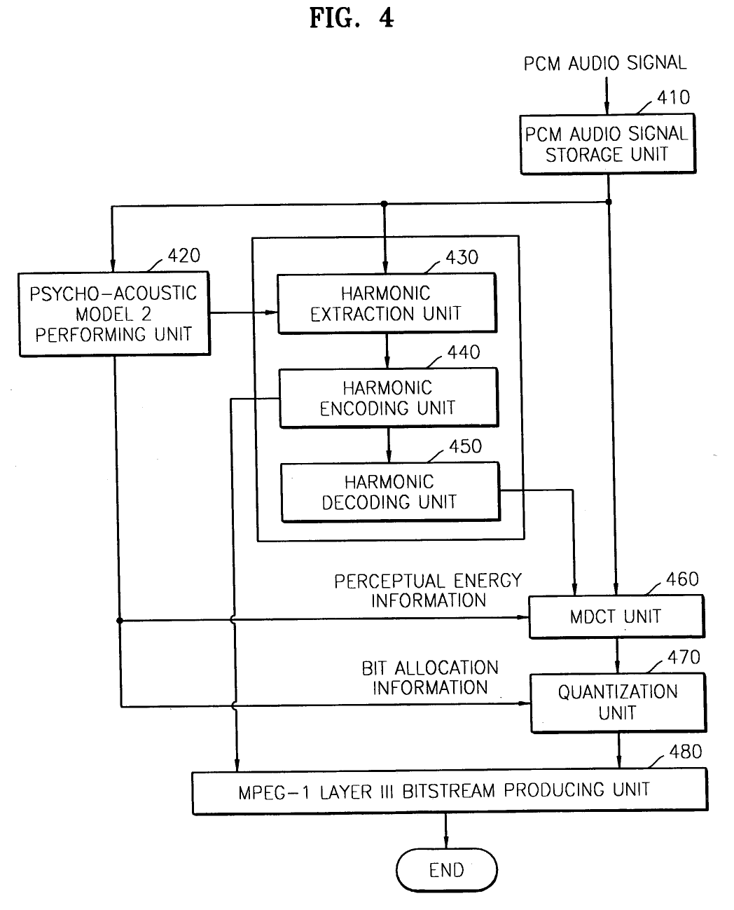

FIG. 4 is a block diagram of an apparatus for producing a low-speed MPEG-1 layer III audio stream, according to the present invention. A PCM audio signal storage unit 410 has a buffer in which it stores PCM audio data. A psycho-acoustic model 2 performing unit 420 performs an FFT on 1024 samples or 256 samples at a time and outputs perceptual energy information and bit allocation information.

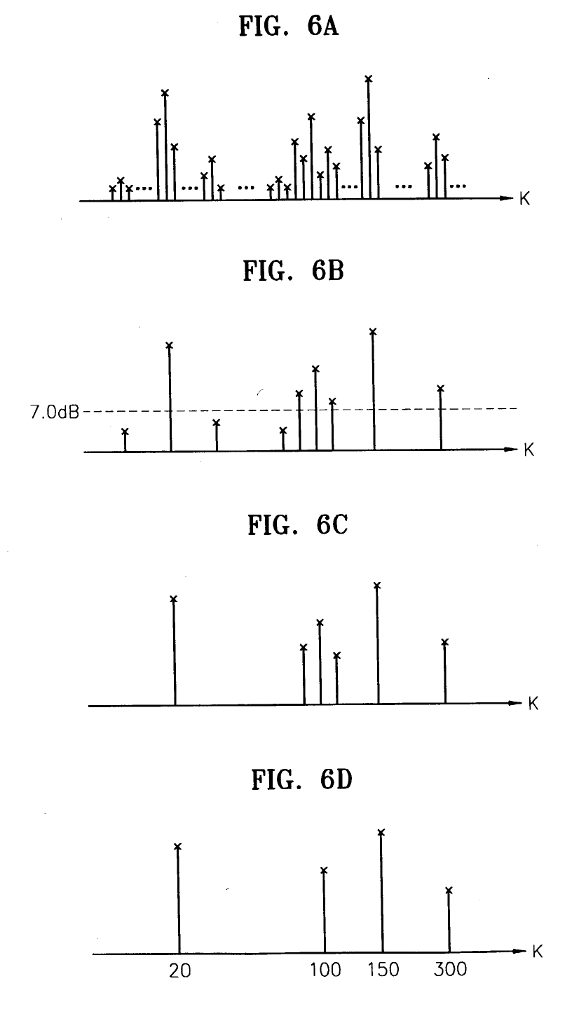

As described above with reference to FIG. 3, when psycho-acoustic model 2 is applied, the perceptual energy information and the bit allocation information that depends on an SMR are output. Since the psycho-acoustic model 2 performing unit 420 performs an FFT, a harmonic extraction unit 430 extracts a harmonic component from the result of the FFT. This feature will be described later with reference to FIG. 6.

A harmonic encoding unit 440 encodes the extracted harmonic component and transmits the encoded harmonic component to an MPEG-1 layer III bitstream producing unit 480. The encoded harmonic component forms MPEG-1 audio, together with quantized audio data. The encoding process of a harmonic component will be described later in detail.

A harmonic decoding unit 450 decodes the encoded harmonic component to obtain PCM data in the time domain. A MDCT unit 460 subtracts the decoded harmonic component from the original input PCM signal and performs a MDCT on the result of the subtraction. More specifically, if the perceptual energy information value received from the psycho-acoustic model 2 unit 420 is greater than a predetermined threshold, a MDCT is performed on 18 samples at a time. If the perceptual energy information value received from the psycho-acoustic model 2 performing unit 420 is equal to or smaller than the predetermined threshold, a MDCT is performed on 36 samples at a time.

The harmonic component extraction is performed on data arranged in a frequency domain using a tonal/non-tonal decision condition and auditory limit characteristics that are defined in psycho-acoustic model 2. This will be described later in detail.

A quantization unit 470 performs quantization using the bit allocation information obtained by the psycho-acoustic model 2 performing unit 420. The MPEG-1 layer III bitstream producing unit 480 packetizes the harmonic component data made by the harmonic encoding unit 440 and quantized audio data obtained by the quantization unit 470 to obtain compressed audio data.

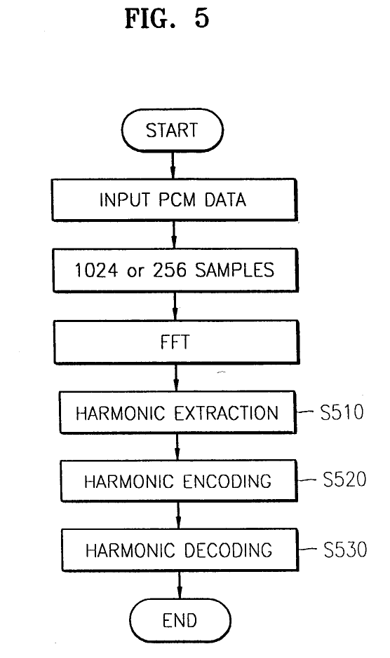

FIG. 5 is a flowchart illustrating a harmonic extraction step S510, a harmonic encoding step S520, and a harmonic decoding step S530 based on psycho-acoustic model 2. The steps performed in psycho-acoustic model 2 in FIG. 5 are the same as the steps performed in psycho-acoustic model 2 in FIG. 3. The result of the FFT performed based on the psycho-acoustic model 2 performing unit is used in step S510 of extracting a harmonic component. The extracted harmonic component is encoded to an MPEG-1 bitstream in step S520. The harmonic extraction step S510 will now be described in greater detail with reference to FIGS. 6A through 6D.

FIGS. 6A, 6B, 6C, and 6D illustrate samples extracted in stages when harmonic components are extracted using the result of the FFT performed in psycho-acoustic model 2. If PCM audio data as shown in FIG. 6A are input, an FFT is first performed on the received data to determine sound pressure for each datum. One of the plurality of received PCM audio data whose sound pressure has been obtained is selected. If the values of the PCM audio data on the left and right sides of the selected data are smaller than the selected PCM audio data value, only the selected PCM audio data is extracted. This process is applied to all of the received PCM audio data.

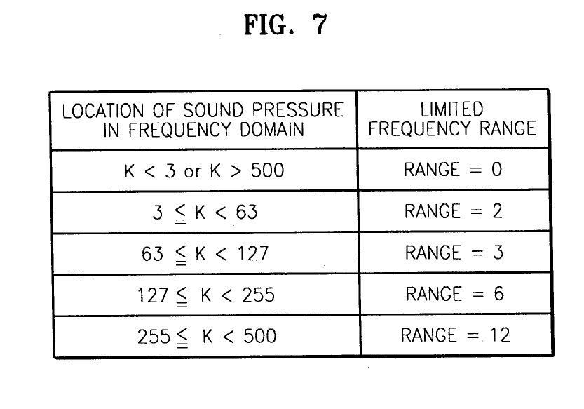

Sound pressure is the energy value of a sample in a frequency domain. In the present invention, only samples having sound pressures that are greater than a predetermined level are determined to be harmonic components. Accordingly, the samples shown in FIG. 6B are extracted. Thereafter, only samples having sound pressures that are greater than a predetermined level are extracted. For example, but not by way of limitation, if the predetermined level is set to be 7.0 dB, samples having sound pressures smaller than 7.0 dB are not selected, and only the samples shown in FIG. 6C remain. The remaining samples are not all considered harmonic components, and some of those samples are therefore extracted from the remaining samples according to the criteria in the table of FIG. 7. Hence, finally, the samples shown in FIG. 6D remain.

FIG. 7 is a table showing a limited frequency range that varies according to a K value. Given that K is a value representing the location of a sample in a frequency domain, if the K value is smaller than 3 or greater than 500, the values of samples present within the limited frequency range of 0 are 0 and accordingly not selected. Likewise, as shown in FIG. 7, if the K value is equal to or greater than 3 and smaller than 63, a corresponding range value is set to be 2. If the K value is equal to or greater than 63 and smaller than 127, a corresponding range value is set to be 3. If the K value is equal to or greater than 127 and smaller than 255, a corresponding range value is set to be 6. If the K value is equal to or greater than 255 and smaller than 500, a corresponding range value is set to be 12.

Setting 500 as the limit was made in consideration of the limit of the audible frequency of a human and was based on an assumption that there is no difference in the quality of reproduced sound between when sample values corresponding to a frequency equal to or greater than 500 are considered and when they are not considered. Consequently, only the sample values of FIG. 6D are extracted and determined to be harmonic components.

The harmonic encoding step S520 includes amplitude encoding, frequency encoding, and phase encoding. These three encoding methods use Equations 1 and 2:

$$\begin{matrix}Enc\_peak \_AmpMax = integer ( \frac{( {2}^{8} - 1 ) {log}_{10} ( AmpMax + 10 )}{{log}_{10} {2}^{13}} ) & ( 1 ) \\ Enc\_Amp = integer ( \frac{( {2}^{5} - 1 ) {log}_{10} ( Amp + 10 )}{{log}_{10} ( AmpMax + 10 )} ) & ( 2 )\end{matrix}$$

wherein AmpMax denotes a peak amplitude, Enc_peak-AmpMax denotes a result value obtained by encoding the value AmpMax, and Amp denotes amplitudes other than the peak amplitude.

In the amplitude encoding, when a peak amplitude is set as the value AmpMax, the peak amplitude is first encoded in a 8-bit log scale to obtain Enc_peak_AmpMax as shown in Equation 1, and the other amplitudes Amp are encoded in a 5-bit log scale to obtain Enc-Amp as shown in Equation 2.

In the frequency encoding, only samples corresponding to values K ranging from 58 (2498 Hz) to 372 (16 KHz) are encoded in consideration of human auditory characteristics. Since 314 is obtained by subtracting 58 from 372, the samples are encoded using 9 bits. The phase encoding is achieved using 3 bits. After such harmonic extraction and harmonic encoding, encoded harmonic components are decoded and then undergo MDCT.

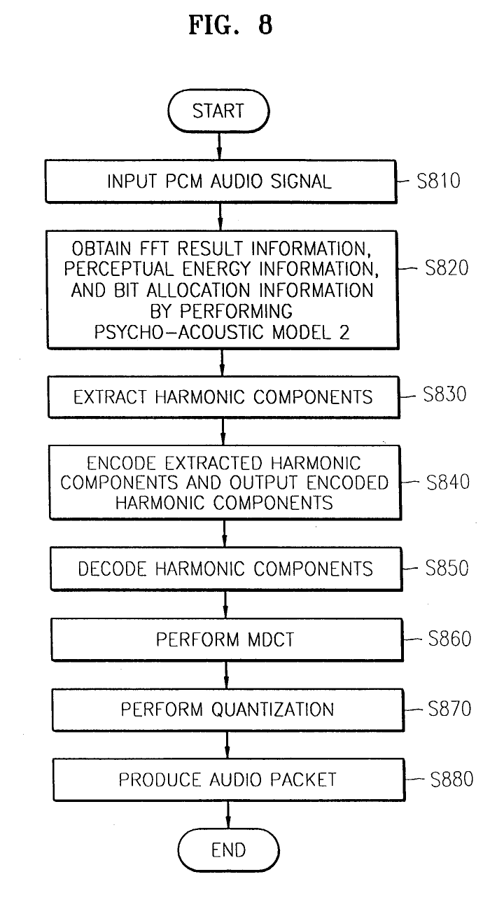

FIG. 8 is a flowchart illustrating a process for producing an audio stream by removing harmonic components, according to an exemplary, non-limiting embodiment of the present invention. First, in step S810, PCM audio data is received and stored. Then, in step S820, psycho-acoustic model 2 using the audible limit characteristics of a human being is applied to the stored data to obtain FFT result information, perceptual energy information regarding the received data, and bit allocation information used for quantization. Thereafter, in step S830, harmonic components are extracted from the received PCM audio data using the FFT result information.

The harmonic components are extracted in the following process. First, sound pressure for each of the plurality of received PCM audio data is obtained using the FFT result information. Next, one of the plurality of received PCM audio data whose sound pressures are obtained is selected. If the values of the PCM audio data on the left and right sides of the selected data are smaller than the value of the selected PCM audio data, only the selected PCM audio data is extracted. This process is applied to all of the received PCM audio data. Thereafter, only PCM audio data that each have sound pressure greater than a predetermined value of for example, but not by way of limitation, a threshold such as 7.0 dB are extracted from the PCM audio data extracted in the previous step. Finally, harmonic components are extracted by not selecting PCM audio data in a predetermined frequency range among the audio data extracted in the previous step.

After the harmonic extraction in step S830, the extracted harmonic components are encoded and output in step S840. Then, encoded harmonic components are decoded in step S850.

Next, in step S860, the received PCM audio data from which the decoded harmonic components are removed is subject to MDCT according to the perceptual energy information. To be more specific, if a perceptual energy value is greater than a predetermined threshold, MDCT is performed using a short window, for example, on 18 samples at a time. If the perceptual energy value is smaller than the predetermined threshold, MDCT is performed using a long window, for example, on 36 samples at a time.

Thereafter, in step S870, the MDCT result values are quantized by allocating bits according to the bit allocation information. Finally, in step S880, the quantized audio data and the encoded harmonic components are subject to Huffman coding to obtain an audio packet.

The embodiments of the present invention can be written as computer programs and can be implemented in general-use digital computers that execute the programs using a computer readable recording medium. Examples of computer readable recording media include magnetic storage media (e.g., ROM, floppy disks, hard disks, etc.), optical recording media (e.g., CD-ROMs, or DVDs), and a storage medium such as a carrier wave (e.g., transmission through the Internet).

While the present invention has been particularly shown and described with reference to preferred embodiments thereof, it will be understood by those of ordinary skill in the art that various changes in form and details may be made therein without departing from the spirit and scope of the present invention as defined by the following claims. Hence, disclosed embodiments must be considered not restrictive but explanatory. The scope of the present invention is not presented in the above description but in the following claims, and all difference in the equivalent scope to the scope of the claims must be interpreted as being included in the present invention.

As described above, in the present invention, the number of quantization bits generated upon production of a low-speed MPEG-1 layer III audio stream is minimized. Using FFT results used in psycho-acoustic model 2, harmonic components are simply removed from an input audio signal, and only a transient portion is compressed using MDCT. Therefore, the input audio signal can be effectively compressed at a low-speed bitrate.

What is claimed is:

1. An audio coding method using harmonic components, comprising:
(a) receiving pulse code modulation (PCM) audio data and extracting harmonic components from the received PCM audio data by applying psycho-acoustic model 2;
(b) performing a modified discrete cosine transform (MDCT) on the received PCM audio data from which the extracted harmonic components are removed; and
(c) quantizing the MDCTed audio data and producing an audio packet from quantized audio data and the extracted harmonic components.

2. An audio coding method using harmonic components, comprising:
(a) receiving and storing pulse code modulation (PCM) audio data and applying psycho-acoustic model 2 based on human audible limit characteristics to the stored data to obtain fast a Fourier transformation (FFT) result, perceptual energy information regarding received data, and bit allocation information used for quantization;
(b) extracting harmonic components from the received PCM audio data using the FFT result information;
(c) encoding the extracted harmonic components, outputting encoded harmonic components, and decoding the encoding harmonic components;
(d) performing a modified discrete cosine transform (MDCT) on a number of samples of the received PCM audio data from which the extracted harmonic components are removed, in accordance with the value of the perceptual energy information;
(e) quantizing the MDCTed audio data by allocating bits according to the bit allocation information; and
(f) producing an audio packet from the quantized, MDCTed audio data and the encoded harmonic components.

3. The audio coding method of claim 2, wherein step (b) comprises:
(b1) obtaining sound pressures for the plurality of received PCM audio data using the FFT result information;
(b2) selecting a data value from the plurality of PCM audio data for which said sound pressure is obtained, and firstly extracting only the selected PCM audio datum if the value of PCM audio data on the right and left sides of the selected PCM audio data value are smaller than the selected PCM audio data value;
(b3) applying said step (b2) to all of the received PCM audio data;
(b4) secondly extracting only the PCM audio data having sound pressures greater than a predetermined sound pressure, from the firstly-extracted PCM audio data; and
(b5) not selecting PCM audio data existing within a predetermined frequency range depending on a frequency location, among the PCM audio data secondly extracted in step (b4).

4. The audio coding method of claim 3, wherein the predetermined sound pressure in said step b4 is 7.0 dB.

5. The audio coding method of claim 2, wherein in step (d), if the value of the perceptual energy information is greater than a predetermined threshold, MDCT is performed on 18 samples at a time, or if the value of the perceptual energy information is smaller than the predetermined threshold, MDCT is performed on 36 samples at a time.

6. An audio coding apparatus using harmonic components, the apparatus comprising:
a pulse code modulation (PCM) audio data storage unit receiving and storing PCM audio data;
a psycho-acoustic model 2 performing unit receiving the PCM audio data from the PCM audio data storage unit and performing psycho-acoustic model 2 to obtain Fast Fourier Transform (FFT) result information, perceptual energy information regarding received data, and bit allocation information used for quantization;
a harmonic extraction unit extracting harmonic components from the received PCM audio data using the FFT result information;
a harmonic encoding unit encoding the extracted harmonic components outputting encoded harmonic components;
a harmonic decoding unit decoding the encoded harmonic components;
an modified discrete cosine transform (MDCT) unit performing MDCT on the stored PCM audio data from which the decoded harmonic components are removed, according to the perceptual energy information;
a quantization unit quantizing the MDCTed audio data according to the bit allocation information; and
an MPEG layer III bitstream production unit transforming the quantized, MDCTed audio data and the encoded harmonic components output from the harmonic encoding unit into an MPEG audio layer III packet.

7. The audio coding apparatus of claim 6, wherein the harmonic extraction unit performs harmonic extraction by:
obtaining sound pressures for the plurality of received PCM audio data using the FFT result information, selecting a datum from the plurality of PCM audio data for which said sound pressures are obtained, and firstly extracting only the selected PCM audio datum if the value of PCM audio data on the right and left sides of the selected PCM audio datum are smaller than the value of the selected PCM audio datum;
applying the first extraction to all of the received PCM audio data, and secondly extracting only the PCM audio data whose sound pressures are greater than a predetermined sound pressure, from the firstly-extracted PCM audio data; and
not selecting PCM audio data that exist within a predetermined frequency range depending on a frequency location, from the secondly-extracted PCM audio data.

8. The audio coding apparatus of claim 6, wherein the MDCT unit performs MDCT on 18 samples if the value of the perceptual energy information is greater than a predetermined threshold, or performs MDCT on 36 samples if the value of the perceptual energy information is smaller than the predetermined threshold.

9. A computer readable recording medium which stores a computer program containing instructions, said instructions comprising:
(a) receiving pulse code modulation (PCM) audio data and extracting harmonic components from the received PCM audio data by applying psycho-acoustic model 2;
(b) performing a modified discrete cosine transform (MDCT) on the received PCM audio data from which the extracted harmonic components are removed; and
(c) quantizing the MDCTed audio data and producing an audio packet from quantized audio data and the extracted harmonic components.

10. A computer readable recording medium which stores a computer program containing instructions, said instructions comprising:
(a) receiving and storing pulse code modulation (PCM) audio data and applying psycho-acoustic model 2 based on human audible limit characteristics to the stored data to obtain fast a Fourier transformation (FFT) result, perceptual energy information regarding received data, and bit allocation information used for quantization;
(b) extracting harmonic components from the received PCM audio data using the FFT result information;
(c) encoding the extracted harmonic components, outputting encoded harmonic components, and decoding the encoding harmonic components;
(d) performing a modified discrete cosine transform (MDCT) on a number of samples of the received PCM audio data from which the extracted harmonic components are removed, in accordance with the value of the perceptual energy information;
(e) quantizing the MDCTed audio data by allocating bits according to the bit allocation information; and
(f) producing an audio packet from the quantized, MDCTed audio data and the encoded harmonic components.

11. The computer readable recording medium of claim 10, wherein step (b) comprises:
(b1) obtaining sound pressures for the plurality of received PCM audio data using the FFT result information;
(b2) selecting a data value from the plurality of PCM audio data for which said sound pressure is obtained, and firstly extracting only the selected PCM audio datum if the value of PCM audio data on the right and left sides of the selected PCM audio data value are smaller than the selected PCM audio data value;
(b3) applying said step (b2) to all of the received PCM audio data;
(b4) secondly extracting only the PCM audio data having sound pressures greater than a predetermined sound pressure, from the firstly-extracted PCM audio data; and
(b5) not selecting PCM audio data existing within a predetermined frequency range depending on a frequency location, among the PCM audio data secondly extracted in step (b4).

12. The computer readable recording medium of claim 11, wherein the predetermined sound pressure in said step b4 is 7.0 dB.

13. The computer readable recording medium of claim 10, wherein in step (d), if the value of the perceptual energy information is greater than a predetermined threshold, MDCT is performed on 18 samples at a time, or if the value of the perceptual energy information is smaller than the predetermined threshold, MDCT is performed on 36 samples at a time.
